(19) United States
(12) Patent Application Publication
(10) Pub. No.: US 2010/0083093 A1
(43) Pub. Date: Apr. 1, 2010

(54) Content Conversion System and Computer Program

(75) Inventors: Gen Hattori, Fujimino-shi (JP); Kazunori Matsumoto, Fujimino-shi (JP); Fumiaki Sugaya, Fujimino-shi (JP)

Correspondence Address: MORGAN LEWIS & BOCKIUS LLP, 1111 PENNSYLVANIA AVENUE NW, WASHINGTON, DC, 20004, US

(73) Assignee: KDDI Corporation, Tokyo (JP)

(21) Appl. No.: 12/093,927

(22) PCT Filed: Nov. 16, 2006
(86) PCT No.: PCT/JP2006/322984

§ 371 Date: May 15, 2008

(30) Foreign Application Priority Data
Nov. 17, 2005 (JP) 2005-332561

(51) Int. Cl. G06F 17/00

(52) U.S. Cl. 715/234

(57) ABSTRACT

A content conversion system of the present invention includes a divider that determines a division point in content data using a determination reference based on a distance (content distance) on a data description between content components in the content data, and divides the content data based on the determination result, a reconstructing unit that reconstructs the divided data as the respective content data, and a division parameter setter that, based on the difference between a variation in distances in the data description between content components in reference content data and a variation in distances in the data description between content components in division target content data, corrects an optimum determination reference of the reference content data, and creates a determination reference for the division target content data.

### TECHNICAL FIELD

The present invention relates to a content conversion system and a computer program.

Priority is claimed on Japanese Patent Application No. 2005-332561, filed Nov. 17, 2005, the content of which is incorporated herein by reference.

### BACKGROUND ART

Recently, mobile phone networks can connect to the internet, and users can use a mobile terminal such as a mobile phone to access websites on the internet. Since mobile terminals generally have a small memory capacity and a small display screen, they cannot display a standard web page intended for a personal computer at that size on the screen. Accordingly, the following Patent Document 1 discloses a conventional technique for dividing a web page and sequentially providing it to a mobile terminal (hereinafter referred to as “conventional technique 1”).

In the convention technique 1, cutting points of a tag structure is detected from content data written in hyper text markup language (HTML), and the contents are divided to small pieces of HTML, based on the upper limit capacity of the mobile terminal. When there is a break tag or a heading tag, the contents are divided to small pieces of HTML using the break tag or heading tag as the boundary. For tables in contents, the number of divisions is determined based on the upper limit capacity to the mobile terminal.

In the conventional technique 1, while a simple web page configuration including text and tables can be divided without much difficulty, there is a drawback that it is difficult to appropriately divide a diverse web page configuration. Accordingly, another conventional technique (hereinafter referred to as “conventional technique 2”) disclosed in the following Non-Patent Document 1 appropriately divides a web page by determining division points in it based on the distance between content components that constitute the web page.

Patent Document 1: Japanese Non-examined Patent Application, First Publication, (JP-A) No. 2001-229106

Non-Patent Document 1: Gen HATTORI, Kazumori MATSUMOTO, and Fumiaki SUGAYA, “Auto Web Page Distilling Scheme Based on Content Distance Using Relative Tag Hierarchy” Database Society of Japan, Letters, Vol. 4, No. 1, 2005

The conventional technique 2 uses determination references of distance between contents for determining division points in the web page. These determination references are set by using an optimum determination reference for each web page by human evaluation (method 1), or using an averagely good determination reference for a limited group of web pages (method 2). However, there are drawbacks in that method 1 requires manual effort, while method 2 leads to a reduction in the division accuracy.

### DISCLOSURE OF THE INVENTION

The present invention has been realized in view of the above circumstances, and aims to provides a content conversion system whereby, if contents such as a web page include content components such as images, text, and hyperlinks, and a display layout of the content components is specified used a tag description such as HTML, when dividing the contents and supplying them to a mobile terminal and the like, the content conversion system can divide original contents appropriately, reduce the amount of human work, and prevent a reduction in the division accuracy.

It is another object of the invention to provide a computer program for realizing the content conversion system of the invention using a computer.

To solve these problems, a content conversion system according to the invention divides content data for displaying contents at a terminal, the content data comprising content components which are displayed on a screen, a display layout of the content components being written using tags, and includes: a division unit that determines a division point in the content data using determination references based on the distance in the data description between content components in the content data, and divides the content data based on the determination result; a reconstruction unit that reconstructs the divided data as the respective content data; and a determination reference creation unit that, based on the difference between a variation in distances in the data description between content components in reference content data and a variation in distances in the data description between content components in division target content data, corrects an optimum determination reference of the reference content data, and creates a determination reference for the division target content data.

Preferably in the content conversion system according to the invention, the determination reference creation unit may include a statistical process unit that calculates a standard deviation of distances in the data description between content components in the content data, and a correction unit that corrects the optimum determination reference of the reference content data, based on the standard deviation.

A computer program according to the invention is a computer program for performing content conversion divides content data for displaying contents at a terminal, the content data comprising content components which are displayed on a screen, a display layout of the content components being written using tags, the program making a computer realize: a function of determining a division point in the content data using a determination reference based on the distance in the data description between content components in the content data, and dividing the content data based on the determination result; a function of reconstructing the divided data as the respective content data; and a function of correcting, based on the difference between a variation in distances in the data description between content components in reference content data and a variation in distances in the data description between content components in division target content data, an optimum determination reference of the reference content data, and creating a determination reference for the division target content data.

Preferably in the computer program according to the invention, the function of creating the determination reference may calculate a standard deviation of distances in the data description between content components in the content data, and corrects the optimum determination reference of the referenced content data, based on the standard deviation.

This enables the content conversion system to be realized using a computer.

According to the invention, since a determination reference of the distance between content components in the tag description for determining a division point of content data such as a web page is set automatically, the human workload required in setting the determination reference is reduced. Further, since appropriate determination references are set for each individual piece of content data that is a division target, it is possible to prevent a reduction in the division accuracy when, for example, dividing a web page and supplying it to a mobile phone, and to appropriately divide the contents of the original web page.

### BRIEF DESCRIPTION OF THE DRAWINGS

FIG. 1 is a block diagram of the configuration of a content conversion system 1 according to an embodiment of the invention.

FIG. 2 is a graph for explanation of content distance according to the same embodiment.

FIG. 3 is a process flowchart of calculating a standard value according to a division parameter calculation of the same embodiment.

FIG. 4 is a process flowchart of calculating specific thresholds for a web page according to a division parameter calculation of this embodiment.

FIG. 5 is a table of results of evaluation tests according to this embodiment.

### BEST MODE FOR CARRYING OUT THE INVENTION

An embodiment of the invention will be explained with standard to the drawings.

Contents according to the invention include content components such as images, texts, and hyperlinks, a display layout of the content component being specified using tag description such as HTML. Content data is, for example, HTML data for displaying the content. This embodiment takes a web page as one example of content according to the invention.

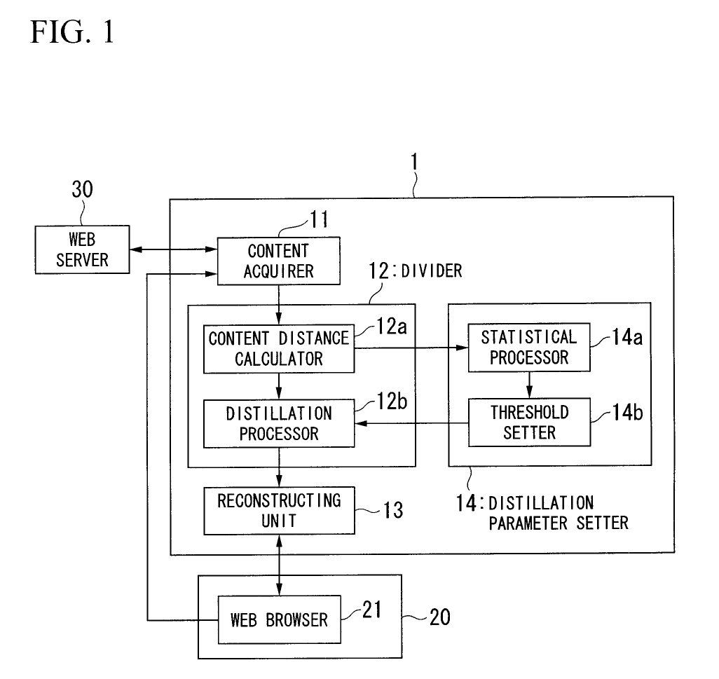

FIG. 1 is a block diagram of the configuration of a content conversion system 1 according to this embodiment. In FIG. 1, the content conversion system 1 includes a content acquirer 11, a divider 12, a reconstructing unit 13, and a division parameter setter 14.

The content conversion system 1 is connected to a communication network. The content conversion system 1 can transmit and receive data to/from a mobile terminal 20 via a communication network such as a mobile phone network. The content conversion system 1 can acquire contents for displaying a web page supplied by a web server 30 that is provided on the interne, by accessing the web server 30.

The mobile terminal 20 includes a web browser 21 that browses each type of web page.

In the content conversion system 1 of FIG. 1, the content acquirer 11 receives a web page acquisition request from the web browser 21, which is operated at the mobile terminal 20, and, in compliance with this request, acquires contents from the web server 30. The contents are for displaying a web page containing content components displayed on a screen at a terminal, a display layout of the content components being described using a tag.

The divider 12 includes a content distance calculator 12a and a division processor 12b. The content distance calculator 12a analyzes HTML data acquired by the content acquirer 11, and calculates the distance in the HTML description between the content components in the HTML data, based on a tag in the HTML data. Hereinafter, the distance between the content components in the HTML description is termed “content distance”.

Based on the content distance calculated by the content distance calculator 12a, the division processor 12b determines a division point in the HTML data. At this time, the division processor 12b determines the division point in the HTML data by using division parameters set from the division parameter setter 14 as content distance determination standards. The division processor 12b divides the HTML data in compliance with the determined division point.

The reconstructing unit 13 performs operations such as appending a header to the pieces of HTML data that are divided by the divider 12, and reconstructs them as complete HTML data. It then returns the reconstructed HTML data sequentially to the mobile terminal 20 in response to the request from the web browser 21.

The division parameter setter 14 includes a statistical processor 14a and a threshold setter 14b.

The statistical processor 14a statistically processes the content distance calculated by the content distance calculator 12a.

The threshold setter 14b calculates threshold as division parameters, based on statistical values of the statistical process results of the statistical processor 14a.

The division parameter setter 14 dynamically sets a division parameter for each web page in the divider 12.

There are not particular limitations regarding the arrangement of the content conversion system 1 on the network. The content conversion system 1 can be realized as an independent apparatus as shown in FIG. 1, or it can be mounted inside the web server 30 or the mobile terminal 20. Alternatively, the content conversion system 1 can be configured as a proxy server.

The content conversion system 1 can be realized by special-purpose hardware, or configured as a general-purpose computer such as a personal computer; the functions of the content conversion system 1 shown in FIG. 1 can also be realized by executing a program for realizing them.

Subsequently, a content conversion operation performed by the content conversion system 1 of this embodiment will be explained.

In this embodiment, the division point in the HTML data is determined based on the distance in the HTML description between content components in the HTML data for displaying the web page. The content components include images, texts, hyperlinks, and such like, which are displayed on the web page. The content distance is obtained by integrating the depths of the nests of all tags described between two content components. The depth of a tag nest expresses the partition ratio of the display layout in the web page.

Therefore, in the display layout in the web page, closely-arranged content components have a shorter distance between them, whereas remotely-arranged content components have a longer distance between them. This tendency is particularly strong in a web page where a complex layout is realized using many stages of table tags and the like. Accordingly, a division point in the HTML data is determined by considering that remote content components have a longer content distance.

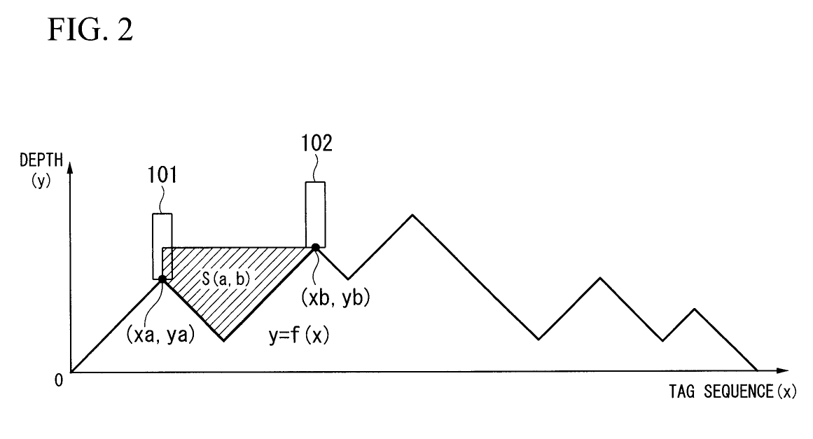

FIG. 2 is a graph for explanation of content distance. In FIG. 2, the horizontal axis represents the tag sequence (x), and the vertical axis represents the tag nest depth (y). In the example of FIG. 2, a content distance S(a,b) is calculated between content components 101 and 102. Specifically, the content distance S(a, b) is calculated from equation (1).

$${S}_{( a , b )} = max \{ \begin{matrix}{\sum }_{i = {x}_{a}}^{{x}_{b}} \vert max \{ {y}_{b} , {y}_{a} \} - f ( i ) \vert , \\ {\sum }_{i = {x}_{a}}^{{x}_{b}} \vert min \{ {y}_{b} , {y}_{a} \} - f ( i ) \vert\end{matrix} \} \qquad ( 1 )$$

where xₐ is the tag sequence of content component 101, yₐ is the depth of the nest of content component 101, x_{b} is the tag sequence of content component 102, and y_{b} is the depth of the nest of content component 102. Also, f(x) is a coefficient that applies the tag nest depth (y) corresponding to the tag sequence (x).

The content distance calculator 12a calculates the content distances between all the content components.

The division processor 12b compares the sizes of the content distances between content components calculated by the content distance calculator 12a, and determines a division point in the HTML data. At this time, the division processor 12b uses division parameters (thresholds N₁ and N₂, where N₁>N₂) set by the division parameter setter 14 as determination standards for the content distance. The sequence of determining the division point in the HTML data (steps S11 to S15) is as follows.

Step S11; the entire web page that is the division target is designated as one content object (Object ID=root).

Step S12; if the maximum content distance value (Smax) in the content object is more than N₁ times the average content distance in the content object (Saverage), a position between the content components corresponding to the maximum value (Smax) is determined to be the division point.

Step S13; when determination using the threshold N₁ of Step S12 is not true, if the maximum value (Smax) is more than N₂ times the average value (Saverage), and the number of content components in the content object after dividing at a position of the content components corresponding to the maximum value (Smax) is more than a threshold M, a position between the content components corresponding to the maximum value (Smax) is determined to be the division point.

Step S14; when a division point of the content object (Object ID=root) is newly discovered in steps S12 and S13, the processes of steps S12 and S13 are performed using the content object of the division result as a target (Object ID=root[left] or root[right]).

Step S15; when a division point of the content object is not newly discovered in steps S12 and S13, processing ends.

The division processor 12b divides the HTML data in compliance with the division point determined by the division point determination processed explained above.

The reconstructing unit 13 receives the divided HTML data from the divider 12. It then performs processes of header-appending and layering to each piece of HTML data, and reconstructs them as complete HTML data. In response to a request from the divider 12, the reconstructing unit 13 sequentially sends the reconstructed HTML data to the mobile terminal 20.

Subsequently, a process of calculating division parameters (thresholds N₁ and N₂) according to this embodiment will be explained.

The division parameters (thresholds N₁ and N₂) are determination references of the content distance for determining a division point in the web page. In this embodiment, thresholds N₁ and N₂ appropriate for each individual web page are calculated dynamically. In the following example, threshold N₁ (hereinafter threshold Nₜ₁) and threshold N₂ (hereinafter threshold Nₜ₂) appropriate to a division target web page T are calculated. A division parameter calculation process of this embodiment includes (1) a reference value determination process, and (2) a calculation process of thresholds Nₜ₁ and Nₜ₂ appropriate for the web page that is the division target.

(1) Reference Value Determination Process

Firstly, a reference value is set as an initial value.

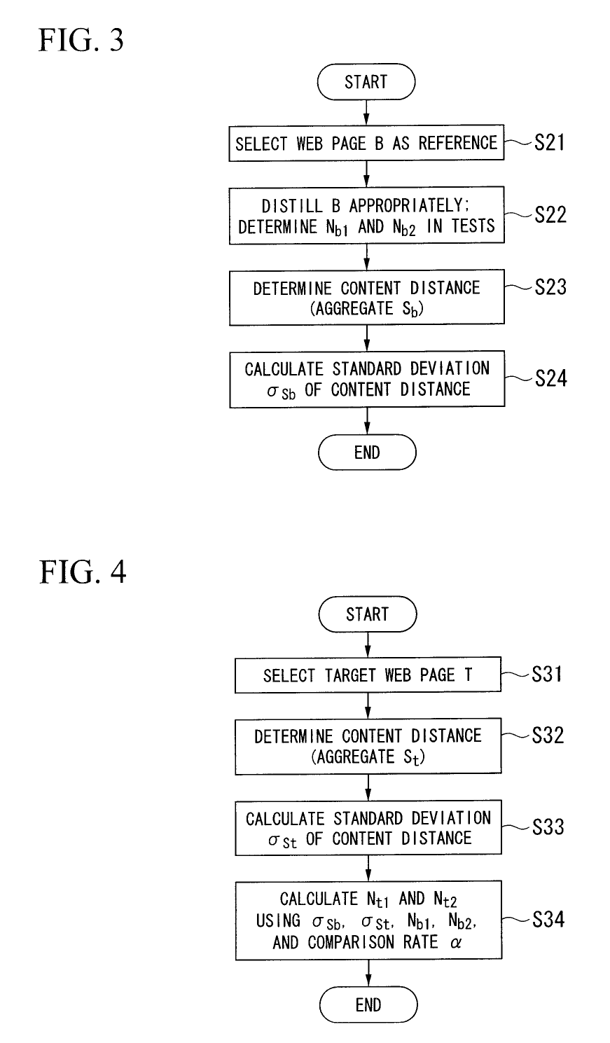

FIG. 3 is a process flowchart of calculating a reference value according to a division parameter calculation process of this embodiment.

In step S21 of FIG. 3, a web page B is arbitrarily selected as a basis.

In step S22, thresholds N₁ and N₂ that can optimally divide web page B are selected in tests by human evaluation. The threshold N₁ thus determined is deemed N_{b1}, and N₂ is deemed N_{b2}.

In step S23, an aggregate S_{b} of the content distances S_{b(i, i+1)} of web page B is calculated.

In step S24, standard deviation σ_{Sb} is calculated using equation (2).

$${σ}_{{S}_{b}} = \sqrt{\frac{{\sum }_{i = 1}^{{n}_{b} - 1} {( {S}_{b}^{′} - {S}_{b ( i , i + 1 )} )}^{2}}{{n}_{b} - 1}} \qquad ( 2 )$$

where S_{b′} is the average value of the content distances in web page B, S_{b(i, i+1)} is the content distance between content component i and content component i+1 of web page B, and n_{b} is the number of content components in web page B.

The division parameter setter 14 stores thresholds N_{b1} and N_{b2}, and the standard deviation σ_{Sb}.

(2) Calculation Process of Thresholds Nₜ₁ and Nₜ₂ Appropriate for the Web Page that is the Division Target

FIG. 4 is a process flowchart of calculating specific thresholds for a web page according to a division parameter calculation of this embodiment.

In step S31 of FIG. 4, a web page T is selected as a division target.

In step S32, an aggregate St of the content distances S_{t(i, i+1)} of web page T is calculated.

In step S33, the standard deviation σ_{St} is calculated using equation (3).

$${σ}_{{S}_{t}} = \sqrt{\frac{{\sum }_{i = 1}^{n - 1} {( {S}_{t}^{′} - {S}_{t ( i , i + 1 )} )}^{2}}{{n}_{t} - 1}} \qquad ( 3 )$$

where St′ is the average value of the content distances in web page T, S_{t(i, i+1)} is the content distance between content component i and content component i+1 of web page T, and nₜ is the number of content components in web page T.

In step S34, thresholds Nₜ₁ and Nₜ₂ are calculated from equations (4) and (5) using the thresholds N_{b1} and N_{b2} set in the reference value setting process, the standard deviation σ_{Sb}, and the standard deviation σ_{St}.

$$\begin{matrix}{N}_{t 1} = {N}_{b 1} + {N}_{b 1} * ( \frac{{σ}_{{S}_{t}}}{{σ}_{{S}_{b}}} - 1 ) * α & ( 4 ) \\ {N}_{t 2} = {N}_{b 2} + {N}_{b 2} * ( \frac{{σ}_{{S}_{t}}}{{σ}_{{S}_{b}}} - 1 ) * α & ( 5 )\end{matrix}$$

where α is a predetermined coefficient (a positive real number). Coefficient α is determined in tests using appropriate values from a plurality of arbitrary web pages.

The division parameter setter 14 sets the thresholds Nₜ₁ and Nₜ₂ as division parameters for web page T in the divider 12.

According to this embodiment, optimum thresholds N_{b1} and N_{b2} are first determined for a reference web page B, and a standard deviation cyst, of the content distances in the web page B is calculated. Based on the thresholds N_{b1} and N_{b2}, thresholds Nₜ₁ and Nₜ₂, which correspond to the ratio between the standard deviation σ_{Sb} of the content distances in standard web page B and the standard deviation σ_{St} of the content distances in division target web page T are calculated, and are set as division parameters for division target web page T. That is, based on the difference between the manner of variation in the content distances of the reference web page B and the manner of variation in the content distances of the division target web page T, division parameters for the division target web page T are created by correction using optimum division parameters of web page B as references.

According to the embodiment described above, since the division parameters can be set automatically, the human workload of setting the division parameters can be reduced. Moreover, since appropriate division parameters are set for each individual division target web page, it is possible to prevent reduction in the division accuracy when dividing a web page and providing it to a mobile terminal, and the contents of an original pre-division web page can be divided appropriately.

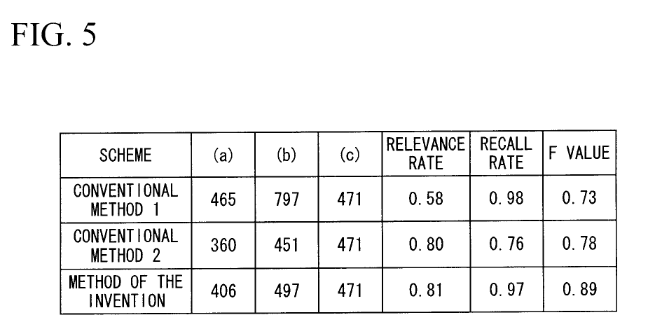

FIG. 5 is a table of results of evaluation tests according to this embodiment. In FIG. 5, conventional method 1 is a method, among the methods described in Non-Patent Document 1, of securely setting optimum thresholds N₁ and N₂ such as to maximize the relevance rate with respect to a specific web page. Conventional method 2 is a method, among the methods described in Non-Patent Document 1, of securely setting optimum thresholds N₁ and N₂ such as to maximize the relevance rate with respect to a specific group of web pages.

In the evaluation tests of FIG. 5, a reference web page used in the method of the invention is the same as a sample one web page used in conventional method 1. This sample one web page is not included in the web page group of conventional method 2. Furthermore, each web page contained in the web page group of conventional method 2 is used as a division target web page. The set values for division parameters in conventional methods 1 and 2 are

Conventional method 1: N₁=2, N₂=1.7

Conventional method 2: N₁=2.9, N₂=2.6

while set values for the reference division parameters in the method of the invention are

N_{b1}=3.4, N_{b2}=2.3, α=0.36

The evaluation parameters are as follows

Relevance rate=Number of correct division positions/Total number of division positions

Recall rate=Number of correct division positions/Total number of correct division positions

F value=Harmonic average value of relevance rate and recall rate.

Here, (a) the number of correct division positions is the number of correct division positions among those of each method, (b) the total number of division positions is the overall number of division positions of each method, and (c) the total number of correct division positions is the overall number of correct positions determined by human evaluation. Here, “correct” indicates that each individual division position that is automatically determined each method matches one of the division positions that are objectively determined as optimum by an evaluator, in a web page displayed on a personal computer using a general web browser.

As shown in FIG. 5, the method of the invention obtains a better F value result than the conventional methods 1 and 2. This confirms the effectiveness of the invention according to the invention.

A content conversion process can be performed by storing a program for realizing the functions of the content conversion system 1 shown in FIG. 1 on a computer-readable recording medium, and making the computer system read and execute the program stored on the recording medium. Here, ‘computer system’ includes hardware such as OS and peripheral devices.

‘Computer system’ includes, if using a WWW system, website providing environments (or display environments).

‘Computer-readable recording medium’ includes portable media such as a flexible disk, an optical-magnetic disk, a ROM, a writable nonvolatile memory such as a flash memory, and a CD-ROM, and storage devices such as hard disk contained in the computer system.

Moreover, ‘computer-readable recording medium’ also includes media that store the program for a fixed time, such as a volatile memory (e.g. a dynamic random access memory {DRAW}) internally provided in computer systems that function as a server and clients when the program is transmitted via a network such as the internet or a communication line such as a telephone cable.

The program can be transmitted from the computer system that stores the program in a storage device and the like via a transmission medium, or by transmitted waves in the transmission medium to another computer system. Here, a ‘transmission medium’ that transmits the program is a medium having a function of transmitting information, e.g. a network (communication network) such as the internet, and a communication cable (communication line) such as a telephone cable.

The program can acceptably implement only some of the functions mentioned above. It can also implement a combination of those functions and other programs already stored in the computer system, known as a differential file (differential program).

While preferred embodiments of the invention have been described and illustrated above, the specific configuration is not limited to these embodiments, and include other designs and the like which are made without departing from the spirit or scope of the present invention.

For example, while the embodiment described above uses standard deviation as an indicator expressing the manner of variation in content distances, another indicator (e.g. total value of dispersion etc.) can be used. For example, it is possible to use a total value expressing the variation such as second-order moment (dispersion), third-order moment (degree of distortion), and fourth-order moment (degree of protrusion).

The method of calculating the content distance is not limited to that described in the embodiment. The total number of tags contained between content components can simply be used as the content distance between the content components. Also, the total sum of weights corresponding to the types of tags contained between content components, such as weights appended to break tags, can be used as the content distance.

### INDUSTRIAL APPLICABILITY

The present invention can be applied in a system that converts contents of web pages and the like, and, since the determination reference for distance in a data description between content components for determining a division point of the content data is set automatically, the human workload required in setting the determination reference setting can be reduced.

1. A content conversion system that divides content data for displaying contents at a terminal, the content data comprising content components which are displayed on a screen, a display layout of the content components being written using tags, comprising:
a division unit that determines a division point in the content data using a determination reference based on the distance in the data description between content components in the content data, and divides the content data based on the determination result;
a reconstruction unit that reconstructs the post-division data as the respective content data; and
a determination reference creation unit that, based on the difference between a variation in distances in the data description between content components in reference content data and a variation in distances in the data description between content components in division target content data, corrects an optimum determination reference of the reference content data, and creates a determination reference for the division target content data.

2. The content conversion system according to claim 1, wherein the determination reference creation unit comprises:
a statistical process unit that calculates a standard deviation of distances in the data description between content components in the content data; and
a correction unit that corrects the optimum determination reference of the reference content data, based on the standard deviation.

3. A computer program for performing content conversion that divides content data for displaying contents at a terminal, the content data comprising content components which are displayed on a screen, a display layout of the content components being written using tags, the program makes a computer realize:
a function of determining a division point in the content data using a determination reference based on the distance in the data description between content components in the content data, and dividing the content data based on the determination result;
a function of reconstructing the divided data as the respective content data; and
a function of correcting, based on the difference between a variation in distances in the data description between content components in reference content data and a variation in distances in the data description between content components in division target content data, an optimum determination reference of the reference content data, and creating a determination reference for the division target content data.

4. The computer program according to claim 3, wherein the function of creating the determination reference calculates a standard deviation of distances in the data description between content components in the content data, and corrects the optimum determination reference of the reference content data, based on the standard deviation.

5. A computer-readable recording medium that stores a program for performing content conversion that divides content data for displaying contents at a terminal, the content data comprising content components which are displayed on a screen, a display layout of the content components being written using tags, the program makes a computer realize:
a function of determining a division point in the content data using a determination reference based on the distance in the data description between content components in the content data, and dividing the content data based on the determination result;
a function of reconstructing the post-division data as the respective content data; and
a function of correcting, based on the difference between a variation in distances in the data description between content components in reference content data and a variation in distances in the data description between content components in division target content data, an optimum determination reference of the reference content data, and creating a determination reference for the division target content data.

6. The computer-readable recording medium according to claim 5, which stores a program that, in the function of creating the determination reference, makes the computer realize a function of calculating a standard deviation of distances in the data description between content components in the content data, and correcting the optimum determination reference of the reference content data, based on the standard deviation.
